(19) United States
(12) Patent Application Publication
(10) Pub. No.: US 2026/0032267 A1
(43) Pub. Date: Jan. 29, 2026

(54) VIDEO ENCODING AND DECODING

(71) Applicant: TENCENT TECHNOLOGY (SHENZHEN) COMPANY LIMITED, Shenzhen (CN)

(72) Inventor: Liqiang WANG, Shenzhen (CN)

(73) Assignee: TENCENT TECHNOLOGY (SHENZHEN) COMPANY LIMITED, Shenzhen (CN)

(21) Appl. No.: 19/347,585

(22) Filed: Oct. 1, 2025

Related U.S. Application Data
(63) Continuation of application No. PCT/CN2024/108635, filed on Jul. 30, 2024.

(30) Foreign Application Priority Data
Aug. 17, 2023 (CN) 202311053293.5

(51) Int. Cl. H04N 19/18; H04N 19/124; H04N 19/176; H04N 19/44

(52) U.S. Cl. CPC H04N 19/18; H04N 19/124; H04N 19/176; H04N 19/44

(57) ABSTRACT

Some aspects of the disclosure provide a method of video decoding. In some examples, values of one or more target quantization coefficients in a target region of quantization coefficients of a current block are obtained. A sub-block transform (SBT) mode of the current block is derived based on the values of the one or more target quantization coefficients in the target region. The current block is reconstructed based on the SBT mode of the current block. Apparatus and non-transitory computer-readable storage medium counterpart embodiments are also contemplated.

### RELATED APPLICATIONS

The present application is a continuation of International Application No. PCT/CN2024/108635, filed on Jul. 30, 2024, which claims priority to Chinese Patent Application No. 202311053293.5, filed on Aug. 17, 2023. The entire disclosures of the prior applications are hereby incorporated by reference.

### FIELD OF THE TECHNOLOGY

This disclosure relates to the field of coding and decoding technologies, including a video coding and decoding method and apparatus, an electronic device, and a computer-readable storage medium.

### BACKGROUND OF THE DISCLOSURE

In a hybrid coding framework, a residual needs to be transmitted to compensate for a predicted image, thereby improving quality of a reconstructed image. In some scenarios, a plurality of sub-block transform (SBT) modes are introduced, and a coder side may perform transform coding processing on only sub-blocks in residual blocks based on the SBT modes, reducing a price of coding residuals. However, a price of coding flag bits of the SBT modes is also introduced, affecting coding and decoding efficiency.

### SUMMARY

Embodiments of this disclosure provide a video coding and decoding method and apparatus, an electronic device, and a computer-readable storage medium, which can improve coding and decoding efficiency.

Some aspects of the disclosure provide a method of video decoding. In some examples, values of one or more target quantization coefficients in a target region of quantization coefficients of a current block are obtained. A sub-block transform (SBT) mode of the current block is derived based on the values of the one or more target quantization coefficients in the target region. The current block is reconstructed based on the SBT mode of the current block.

Some aspects of the disclosure provide an apparatus that includes processing circuitry configured to perform the method of video decoding.

Some aspects of the disclosure also provide a non-transitory computer-readable storage medium storing instructions which when executed by at least one processor cause the at least one processor to perform the method of video decoding.

Some aspects of the disclosure provide a method of video encoding. In some examples, a sub-block transform (SBT) mode for a current block is determined to be used. A transform operation is performed on a residual portion of the current block based on the SBT mode to obtain transform coefficients of the current block. A quantization operation is performed on the transform coefficients to obtain quantization coefficients of the current block. At least a value of a target quantization coefficient in a target region of the quantization coefficients of the current block is determined based on the SBT mode of the current block, the at least the value of the target quantization coefficient is indicative of the SBT mode. A video that includes the current block with at least the value of the target quantization coefficient is encoded into coded information in a bitstream.

Some aspects of the disclosure provide an apparatus that includes processing circuitry configured to perform the method of video encoding.

Some aspects of the disclosure also provide a non-transitory computer-readable storage medium storing instructions which when executed by at least one processor cause the at least one processor to perform the method of video encoding.

According to a first aspect, a video decoding method is provided, including: obtaining a target quantization coefficient in a target region in a current block; determining a sub-block transform (SBT) mode corresponding to the current block based on the target quantization coefficient in the target region; and decoding the current block based on the SBT mode corresponding to the current block.

According to a second aspect, a video encoding method is provided, including: determining an SBT mode corresponding to a current block; and determining a target quantization coefficient in a target region in the current block based on the SBT mode corresponding to the current block.

According to a third aspect, a video decoding apparatus is provided, including: an obtaining unit, configured to obtain a target quantization coefficient in a target region in a current block; a determining unit, configured to determine an SBT mode corresponding to the current block based on the target quantization coefficient in the target region; and a decoding unit, configured to decode the current block based on the SBT mode corresponding to the current block.

According to a fourth aspect, a video coding apparatus is provided, including: a first determining unit, configured to determine an SBT mode corresponding to a current block; and a second determining unit, configured to determine a target quantization coefficient in a target region in the current block based on the SBT mode corresponding to the current block.

According to a fifth aspect, a video decoding apparatus is provided, including a communications bus, a processor, a communications interface, and a memory, the processor, the communications interface, and the memory being connected to each other through the communications bus, the memory being configured to store program code, and the processor being configured to invoke the program code to perform the method in the foregoing first aspect.

According to a sixth aspect, a video coding apparatus is provided, including a communications bus, a processor (an example of processing circuitry), a communications interface, and a memory, the processor, the communications interface, and the memory being connected to each other through the communications bus, the memory being configured to store program code, and the processor being configured to invoke the program code to perform the method in the foregoing second aspect.

According to a seventh aspect, a video coding and decoding system is provided, including the video decoding apparatus in the third aspect and the video coding apparatus in the fourth aspect; or the video decoding apparatus in the fifth aspect and the video coding apparatus in the sixth aspect.

According to an eighth aspect, a computer storage medium is provided, the computer storage medium having a computer program stored therein, the computer program including program instructions, the program instructions, when executed by a processor, causing the processor to perform the method in the foregoing first aspect.

According to an eighth aspect, a computer storage medium (e.g., non-transitory computer-readable storage medium) is provided, the computer storage medium having a computer program stored therein, the computer program including program instructions, the program instructions, when executed by a processor, causing the processor to perform the method in the foregoing second aspect.

Based on the foregoing technical solution, a decoder side determines the SBT mode corresponding to the current block based on the target quantization coefficient in the target region in the current block, to implicitly derive the SBT mode used for the current block based on the target quantization coefficient in the target region in the current block, so that a coder side may not explicitly code a flag bit of the SBT mode used for the current block, thereby saving a bit rate and improving coding and decoding efficiency.

### BRIEF DESCRIPTION OF THE DRAWINGS

FIG. 1 is a schematic diagram of an exemplary system architecture applicable to an embodiment of this disclosure.

FIG. 2 is a basic flowchart of a video coder.

FIG. 3 is a schematic diagram of eight sub-block division manners.

FIG. 4 is a schematic diagram of sub-block transform (SBT) modes corresponding to the eight sub-block division manners in FIG. 3.

FIG. 5 is a schematic diagram of 16 sub-block division manners.

FIG. 6 is a schematic diagram of SBT modes corresponding to the 16 sub-block division manners in FIG. 5.

FIG. 7 is a schematic flowchart of a video decoding method according to an embodiment of this disclosure.

FIG. 8 is a schematic diagram of a target quantization coefficient in a target region according to an embodiment of this disclosure.

FIG. 9 is a schematic flowchart of a video coding method according to an embodiment of this disclosure.

FIG. 10 is a schematic diagram of a video decoding apparatus according to an embodiment of this disclosure.

FIG. 11 is a schematic diagram of a video coding apparatus according to an embodiment of this disclosure.

FIG. 12 is a schematic diagram of an electronic device according to an embodiment of this disclosure.

### DESCRIPTION OF EMBODIMENTS

The following describes technical solutions in embodiments of this disclosure with reference to the accompanying drawings. The described embodiments are some of the embodiments of this disclosure rather than all of the embodiments. Other embodiments are within the scope of this disclosure.

In addition, the described features, structures, or characteristics may be combined in one or more embodiments in any proper manner. In the following descriptions, a lot of details are provided to give a comprehensive understanding of the embodiments of this disclosure. It is noted that, the technical solutions in this disclosure may be implemented without one or more of the particular details, or another method, unit, apparatus, or operation may be used. Also, some methods, apparatuses, implementations, or operations are not shown or described in detail, to avoid obscuring the aspects of this disclosure.

Block diagrams shown in the drawings are merely functional entities, and do not necessarily correspond to physically independent entities. In other words, the functional entities may be implemented in a form of software, or may be implemented in one or more hardware modules or integrated circuits, or may be implemented in different networks and/or processor apparatuses and/or microcontroller apparatuses.

The flowcharts shown in the drawings are merely exemplary descriptions, and neither necessarily need to include all content and operations, nor necessarily need to be performed in the described order. For example, some operations/steps may be further divided, while some operations/steps may be merged or partially merged. Therefore, an actual execution order may change according to an actual case.

“A plurality of” mentioned herein means two or more. “And/or” describes an association relationship between associated objects, and indicates that three relationships may exist. For example, A and/or B may represent that: only A exists, both A and B exist, and only B exists. A character “/” generally indicates that the associated objects are in an “or” relationship.

To have a better understanding of the embodiments of this disclosure, a system architecture applicable to the embodiments of this disclosure is described.

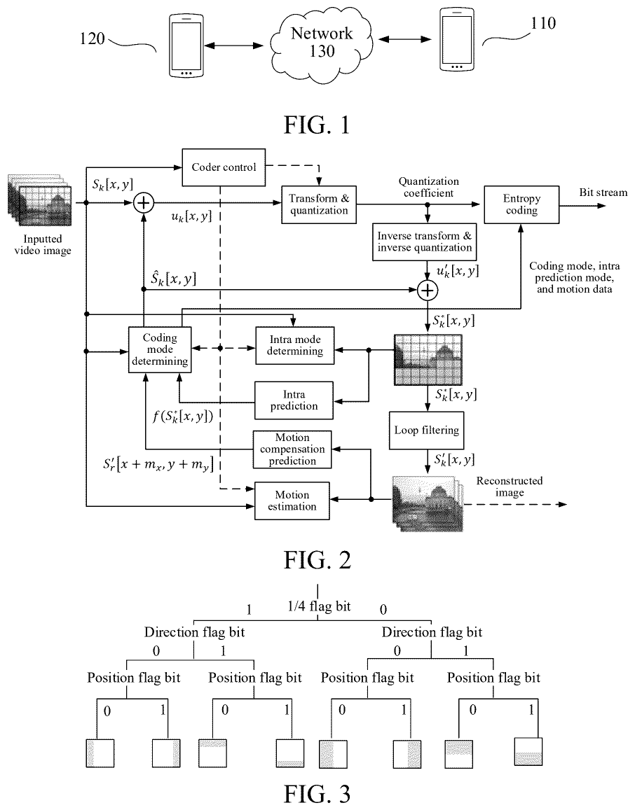

FIG. 1 is a schematic diagram of a system architecture applicable to an embodiment of this disclosure. As shown in FIG. 1, a system architecture 100 may include a plurality of terminals. The plurality of terminals may communicate with each other through a network 130. For example, the system architecture 100 may include a first terminal 110 and a second terminal 120. The first terminal 110 and the second terminal 120 perform data transmission through the network 130.

For example, the first terminal 110 may code video data (for example, a video picture stream captured by the first terminal 110) and transmit the coded video data to the second terminal 120 through the network 130. The coded video data is transmitted in a form of one or more coded video bit streams. The second terminal 120 may receive the coded video data through the network 130, decode the coded video data to recover the video data, and display a video picture based on the recovered video data.

In some scenarios, the system architecture may further include more terminals, for example, a third terminal and a fourth terminal. The third terminal and the fourth terminal may perform data transmission through the network 130.

The terminal in the embodiments of this disclosure may be a server, a personal computer, a tablet computer, a smart phone, a media player, and/or a dedicated video conferencing device, but this disclosure is not limited thereto.

The network 130 may include any number of networks configured to transmit coded video data between terminals, for example, include a wired network and/or a wireless network. The network 130 may exchange data in a circuit switching channel and/or a packet switching channel. The network may include a telecommunication network, a local area network, a wide area network, and/or the Internet.

To have a better understanding of the embodiments of this disclosure, video coding technologies related to the embodiments of this disclosure are described.

In some embodiments of this disclosure, international video coding standards such as high efficiency video coding (HEVC), versatile video coding (VVC), and the Chinese national video coding standard (such as the audio video coding standard (AVS)) are used as examples, and a hybrid coding framework is adopted to perform the following operations and processing on an inputted original video signal.

1) Block partition structure: An inputted video image frame is partitioned into a plurality of non-overlapping processing units based on a block size, and a similar compression operation is performed on each processing unit. The processing unit is referred to as a coding tree unit (CTU) or a largest coding unit (LCU). The CTU may be further partitioned into one or more basic coding units (CU). The CU is the most basic element in a coding process. Various coding modes that may be used for each CU are described below. 2) Predictive coding: It includes manners such as intra prediction and inter prediction. After an original video signal is subjected to a selected reconstructed video signal prediction, a residual video signal is obtained. A coder side needs to select a most suitable predictive coding mode for a current CU from many possible predictive coding modes, and notify a decoder side of the mode.

a: Intra prediction: A predicted signal comes from a region that has been coded and reconstructed in the same image.

b: Inter prediction: A predicted signal comes from another coded image (referred to as a reference image) that is different from a current image.

3) Transform & quantization: A residual video signal is transformed into a transform domain through a transform operation such as discrete Fourier transform (DFT) or discrete cosine transform (DCT), to generate a transform coefficient. A lossy quantization operation is further performed on the signal in the transform domain, which loses a specific amount of information, so that the quantized signal facilitates compression and expression. In some video coding standards, two or more transform manners may be selected. Therefore, the coder side also needs to select one of the transform manners for a current to-be-coded CU, and notify the decoder side of the manner. A degree of the quantization generally depends on a quantization parameter (QP). A larger QP indicates that coefficients in a larger value range are to be quantized into the same output, which usually brings larger distortion and a lower bit rate. A smaller QP indicates that coefficients within a smaller value range are to be quantized to the same output, which usually brings smaller distortion and a higher bit rate.

4) Entropy coding or statistical coding: Statistical compression coding is performed on a quantized signal in a transform domain based on a frequency of occurrence of each value, and finally a binarized (0 or 1) compressed bit stream is outputted. In addition, entropy coding further needs to be performed on other information generated during the coding, such as the selected coding mode and motion vector data, to reduce a bit rate. Statistical coding is a lossless coding mode that can effectively reduce a bit rate required for expressing the same signal. Common statistical coding modes include variable length coding (VLC) or context adaptive binary arithmetic coding (CABAC).

5) Loop filtering: Operations such as inverse quantization, inverse transform, and predictive compensation (the foregoing operations in 2 to 4) may be performed on a coded image to obtain a reconstructed decoded image. The reconstructed image has some different information from an original image as a result of quantization, resulting in distortion. Therefore, a filtering operation may be performed on the reconstructed image, for example, by using filters such as a deblocking filter (DB), a sample adaptive offset (SAO) filter, or an adaptive loop filter (ALF), which can effectively reduce a degree of distortion caused by quantization. Since the filtered reconstructed image will be used as a reference for subsequent image coding so as to predict future signals, the foregoing filtering operation is also referred to as loop filtering, that is, a filtering operation in a coding loop.

FIG. 2 is a basic flowchart of a video coder. In this process, intra prediction is used as an example for description. A difference between an original image signal Sₖ[x, y] and a predicted image signal Ŝₖ[x, y] is calculated to obtain a residual signal uₖ[x, y], and the reference signal uₖ[x, y] is transformed and quantized to obtain a quantization coefficient. The quantization coefficient is subjected to entropy coding to obtain a coded bit stream, and is further subjected to inverse quantization and inverse transform to obtain a reconstructed residual signal uₖ′[x,y]. The predicted image signal Ŝₖ[x,y] and the reconstructed residual signal

$${u}_{k}^{′} [ x , y ]$$

are superposed to generate an image signal

$${S}_{k}^{*} [ x , y ] .$$

The image signal

$${S}_{k}^{*} [ x , y ]$$

is inputted to an intra mode determining module and an intra prediction module for intra prediction and is further subjected to loop filtering to output a reconstructed image signal

$${S}_{k}^{′} [ x , y ] .$$

The reconstructed image signal

$${S}_{k}^{′} [ x , y ]$$

may be used as a reference image for a next frame for motion estimation and motion compensation prediction. Then a predicted image signal Ŝₖ[x, y] of the next frame is obtained based on a result

$${S}_{r}^{′} [ x + {m}_{x} , y + {m}_{y} ]$$

of the motion compensation prediction and a result

$$f ( {S}_{k}^{*} [ x , y ] )$$

of the intra prediction. The foregoing process is repeated until the coding is completed.

It may be seen from the foregoing coding process that, on the decoder side, for each CU, after the decoder obtains a compressed bit stream, the decoder first performs entropy decoding to obtain all kinds of mode information and quantization coefficients, and then performs inverse quantization and inverse transform on the quantization coefficients to obtain a residual signal. Moreover, a predicted signal corresponding to the CU may be obtained based on coding mode information that is known. Then the residual signal and the predicted signal may be added together to obtain a reconstructed signal. The reconstructed signal is then subjected to operations such as loop filtering to generate a final output signal.

Due to a relatively large error of a prediction method, a residual needs to be transmitted to compensate for the predicted image, thereby improving quality of a reconstructed image. Therefore, residual processing is an important process in a hybrid coding framework.

As shown in FIG. 2, in the hybrid coding framework, the residual is a difference between the original image signal and the predicted image signal, that is, uₖ[x, y]=Sₖ[x,y]−Ŝₖ[x,y].

For residual processing, the following two processing manners exist in the HEVC, VVC, and AVS3 video coding standards:

### 1) Transform and Quantization:

Based on correlation between residuals, energy concentration is performed on the residuals through transform, so that energy concentrates in few low-frequency coefficients. In other words, most coefficients have relatively small values. After processing by a subsequent quantization module, the relatively small coefficient values become zero, which greatly reduces a price of coding the residuals. Using the conventional DCT as an example, the transform is shown in the following formula. Two-dimensional discrete transform is implemented through two separate one-dimensional discrete transform processes (horizontal transform and vertical transform).

$${Co}_{k} = {CU}_{k} {C}^{T}$$

Due to diversified residual distribution, single DCT cannot adapt to all residual characteristics. Therefore, transform kernels such as DST-7 and DCT-8 are applied to a transform module, and the horizontal transform and the vertical transform may be performed by using different transform kernels. An adaptive multiple core transform (AMT) technology is used as an example. Possible combinations of transform kernels for a residual block include one or more of the following:
(DCT-2, DCT-2)
(DCT-8, DCT-8)
(DCT-8, DST-7)
(DST-7, DCT-8)
(DST-7, DST-7)

A specific combination of transform kernels for a residual block may be determined through rate distortion optimization (RDO) on the coder side. Using a plurality of transform kernels can improve adaptability of the transform module to the residual, but a consequence is a price of coding a transform kernel index.

2) Transform skip and quantization: For residuals having small correlation, transform skip is adopted based on 1), which brings higher coding efficiency. For example, a transform process for the residuals is skipped, and quantization is directly performed on the residuals.

To have a better understanding of the embodiments of this disclosure, a sub-block transform (SBT) mode related to the embodiments of this disclosure is described. In the SBT mode, the coder side needs to perform transform and coding on only one sub-block of a current to-be-coded block, thereby reducing a price of coding.

The SBT mode of the current block may include a sub-block division manner of the current block, the sub-block division manner being configured for dividing the current block into sub-blocks. The sub-block division manner may be represented by information such as a size of a sub-block and a position of a sub-block in a current block.

FIG. 3 is a schematic diagram of eight SBT modes (or sub-block division manners) in a current block. A quarter (quad) flag bit is size control syntax for sub-blocks in the current block. A value of 1 of the quad flag bit indicates that a size of a sub-block is ¼ of a size of the current block after quadtree division is performed on the current block, and a value of 0 indicates that a size of a sub-block is ½ of the size of the current block. A direction (dir) flag bit and a position (pos) flag bit are syntax configured for controlling a position of a sub-block in the current block. The dir flag bit is configured for controlling a direction, such as horizontal or vertical, of the sub-block in the current block, and the pos flag bit is configured for controlling a position, such as left or right and up or down, of the sub-block. That is, the quad flag bit defines the size (a shape) of the sub-block, and the dir flag bit and the pos flag bit define the position of the sub-block. In other words, the division manner of the current block may be represented by the size of the sub-block and the direction and the position of the sub-block in the current block.

In some embodiments, in the foregoing eight sub-block division manners, transform coding is performed on only gray sub-blocks, and white sub-block are forcibly cleared. Alternatively, transform may be skipped in a residual coding process of the gray sub-blocks, and quantization and coding are directly performed.

In some embodiments, a sub-block division manner and an SBT manner of a current block have an association relationship. For example, the SBT manner may be preset based on the sub-block division manner of the current block and a position of a sub-block, and no additional coded bit is needed for identification. Therefore, it may also be considered that an SBT mode of the current block includes the sub-block division manner and the SBT manner of the current block. In some embodiments, the SBT manner may be represented by a transform kernel used for SBT.

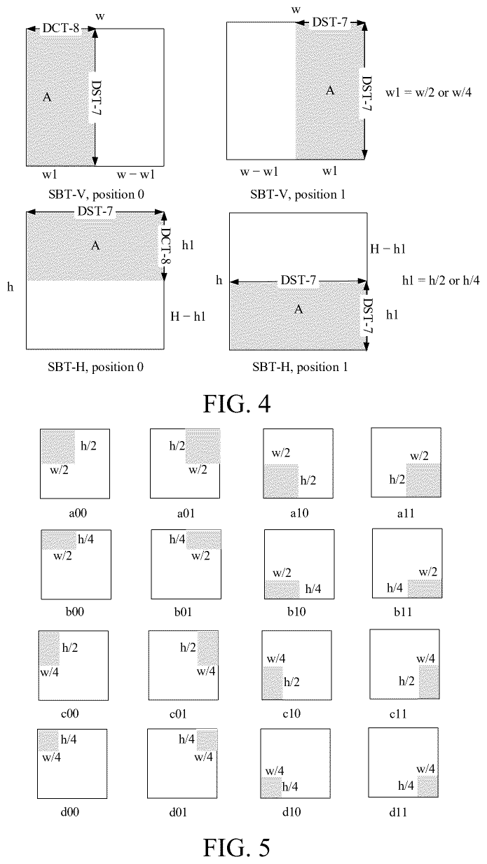

For example, for selection of a combination of transform kernels for a sub-block, when a width or a height of a non-0 residual sub-block is 64, transform kernels for horizontal and vertical transform of the non-0 residual sub-block are both DCT-2. Selection of transform kernels for horizontal and vertical transform in other cases may be shown in FIG. 4. In FIG. 4, white sub-blocks are 0 residual sub-blocks, and gray sub-blocks are non-0 residual sub-blocks.

To have a better understanding of the embodiments of this disclosure, an SBT extension mode related to the embodiments of this disclosure is described.

In some scenarios, an extension mode of an SBT mode in FIG. 5 is introduced based on the SBT mode, so that transform efficiency can be additionally improved. Similar to the SBT mode, only residuals of gray sub-block regions are coded, and residuals of white regions are forcibly cleared.

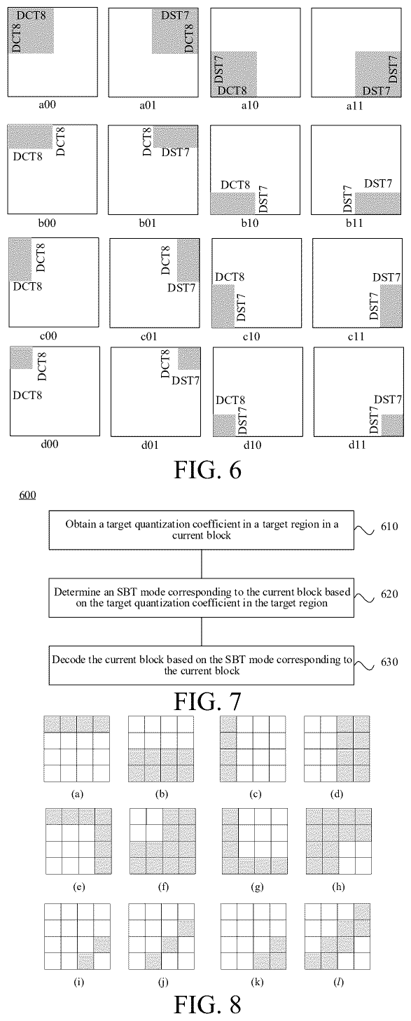

In some embodiments, SBT manners for 16 sub-block division manners in FIG. 5 may be shown in FIG. 6. The coder side performs transform coding on only gray sub-blocks in a current block, and forcibly clear white sub-blocks. Alternatively, transform may be skipped in a residual coding process of the gray sub-blocks, and quantization and coding are directly performed.

In the sub-block division manners shown in FIG. 5, a00 to all, b00 to b11, c00 to c11, and d00 to d11 may be respectively considered as a mode type. In some embodiments, at least one may be selected from the four mode types as the extension mode of the SBT mode. Gray sub-blocks in four modes in each mode type are respectively located at upper left, upper right, lower left, and lower right positions of an entire to-be-coded bloc. Therefore, each mode type may be identified through two flag bits: hor_idx (a horizontal flag index, or referred to as a horizontal position flag bit) and ver_idx (a vertical flag index, or referred to as a vertical position flag bit). In other words, the sub-block division manner of the current block may be represented by a horizontal size and a vertical size of the sub-block, and a horizontal position and a vertical position of the sub-block in the current block.

TABLE 1

| Sub-block extension mode | (hor_idx, ver_idx) |
|---|---|
| Upper left mode (a00, b00, c00, d00) | (0, 0) |
| Upper right mode (a01, b01, c01, d01) | (1, 0) |
| Lower left mode (a10, b10, c10, d10) | (0, 1) |
| Lower right mode (a11, b11, c11, d11) | (1, 1) |

Using the SBT mode on the coder side can improve transform efficiency, which however, also introduces a price of coding the flag bits of the SBT mode, which affects coding and decoding efficiency. Therefore, how to improve transform efficiency through the SBT mode while ensuring the coding and decoding efficiency is a problem that needs to be resolved urgently.

In view of this, this disclosure provides a technical solution. An SBT mode corresponding to a current block may be implicitly indicated by using some or all target quantization coefficients in a target region of the current block, to reduce a price of coding flag bits of the SBT mode on a coder side, and improve coding and decoding efficiency.

FIG. 7 is a flowchart of a video decoding method according to an embodiment of this disclosure. The video decoding method may be performed by a decoder side. The decoder side may be a device with a computing processing function, or may be arranged in a device with a computing processing function. The device with a computing processing function may be, for example, a terminal device or a server. As shown in FIG. 7, a video decoding method 600 includes at least some of the following contents:

S610: Obtain a target quantization coefficient in a target region in a current block.

S620: Determine an SBT mode corresponding to the current block based on the target quantization coefficient in the target region.

S630: Decode the current block based on the SBT mode corresponding to the current block.

Therefore, in this embodiment of this disclosure, a decoder side determines the SBT mode corresponding to the current block based on the target quantization coefficient in the target region in the current block, to implicitly derive the SBT mode used for the current block based on the target quantization coefficient in the target region in the current block, so that a coder side may not explicitly code a flag bit of the SBT mode used for the current block, thereby saving a bit rate and improving coding and decoding efficiency.

In some embodiments of this disclosure, a video image frame sequence includes a series of video image frames. Each video image frame may be further partitioned into slices. Each slice may be further partitioned into a series of LCUs (or CTUs). Each LCU includes a plurality of CUs.

In some embodiments of this disclosure, the video image frame is coded in a unit of a block. In some video coding standards, for example, in the H. 264 standard, a macroblock (MB) is provided. The MB may be further partitioned into a plurality of prediction blocks that may be configured for predictive coding. In the HEVC standard, basic concepts such as a CU, a prediction unit (PU), and a transform unit (TU) are used, and various block units are defined in terms of function.

The current block in this embodiment of this disclosure may be a block unit defined in terms of function, for example, may be a current CU, a current PU, a current TU, or a current quantization block, or may be a block smaller than a CU, a PU, a TU, or a quantization block, for example, a smaller block obtained partitioned from the CU, the PU, the TU, or the quantization block.

In some embodiments of this disclosure, the SBT mode may be an SBT mode in AVS3, VCC, or another video coding standard, or may be an extension mode of an SBT mode.

In some embodiments of this disclosure, the SBT mode may be represented by a size flag bit and a position flag bit, the size flag bit being configured for identifying at least one of a horizontal size and a vertical size of the SBT, and the position flag bit being configured for identifying at least one of a horizontal position and a vertical position of the SBT.

In some embodiments, the size flag bit is also referred to as a type flag bit or a size type flag bit. For example, different state values of the size flag bit represent different combinations of a horizontal size and a vertical size of the SBT.

In an example, the size flag bit may be two bits, and different state values of the two bits represent different combinations of a horizontal size and a vertical size of the SBT.

For example, as shown in FIG. 5, a00 to all correspond to a size type, that is, a horizontal size is W/2, and a vertical size is H/2; b00 to b11 correspond to a size type, that is, a horizontal size is W/2, and a vertical size is H/4; c00 to c11 correspond to a size type, that is, a horizontal size is W/4, and a vertical size is H/2; and d00 to d11 correspond to a size type, that is, a horizontal size is W/4, and a vertical size is H/4.

For example, different state values of the two bits of the size flag bit represent the foregoing four size types. For example, 00 represents a combination of W/2 and H/2, 01 represents a combination of W/2 and H/4, 10 represents a combination of W/4 and H/2, and 11 represents a combination of W/4 and H/4. The foregoing correspondence between a state value and a size type is merely an example, provided that each size type corresponds to a unique state value. This is not limited in this disclosure.

In some embodiments of this disclosure, when the size flag bit is configured for identifying the horizontal size and the vertical size of the SBT, the size flag bit may include a horizontal size flag bit and a vertical size flag bit. The horizontal size flag bit is configured for identifying the horizontal size of the SBT, and the vertical size flag bit is configured for identifying the vertical size of the SBT. In other words, the horizontal size and the vertical size of the SBT may be respectively indicated through an independent flag bit. For example, different state values of the horizontal size flag bit represent different horizontal sizes of the SBT, and different state values of the vertical size flag bit represent different vertical sizes of the SBT.

In an example, the horizontal size flag bit is one bit. Different state values of the bit are configured for indicating whether the horizontal size of the SBT is W/4 or W/2. For example, a state value of 0 represents W/2, and a state value of 1 represents W/4, or vice versa.

In an example, the vertical size flag bit is one bit. Different state values of the bit are configured for indicating whether the vertical size of the SBT is H/4 or H2. For example, a state value of 0 represents H2, and a state value of 1 represents H/4, or vice versa.

In some embodiments of this disclosure, the position flag bit may be two bits, and different state values of the two bits represent different combinations of a horizontal position and a vertical position of the SBT. For example, different state values of the two bits represent four positions in the example shown in FIG. 5: upper left (a00, b00, c00, d00), upper right (a01, b01, c01, d01), lower left (a10, b10, c10, d10), and lower right (al1, b11, c11, d11). For example, 00 represents upper left, 01 represents upper right, 10 represents lower left, and 11 represents lower right. The foregoing correspondence between a state value and a position combination is merely an example, provided that each position combination corresponds to a unique state value. This is not limited in this disclosure.

In some embodiments of this disclosure, when the position flag bit is configured for identifying the horizontal position and the vertical position of the SBT, the position flag bit may include a horizontal position flag bit (for example, hor_idx) and a vertical position flag bit (for example, ver_idx). The horizontal position flag bit is configured for identifying the horizontal position of the SBT, and the vertical position flag bit is configured for identifying the vertical position of the SBT. In other words, the horizontal position and the vertical position of the SBT may be respectively indicated through an independent flag bit.

In some embodiments of this disclosure, different state values of the horizontal position flag bit are configured for identifying different horizontal positions of the SBT. For example, the horizontal position flag bit may be one bit, and different state values of the bit are configured for indicating whether the horizontal position of the SBT is left or right. For example, a state value of 0 represents left, and a state value of 1 represents right, or vice versa.

In some embodiments of this disclosure, different state values of the vertical position flag bit are configured for identifying different vertical positions of the SBT. For example, the vertical position flag bit may be one bit, and different state values of the bit are configured for indicating whether the vertical position of the SBT is up or down. For example, a state value of 0 indicates up, and a state value of 1 indicates down, or vice versa.

In some embodiments of this disclosure, S620 may include:
determining a target flag bit corresponding to the SBT mode based on the target quantization coefficient in the target region, the target flag bit including at least one of a size flag bit and a position flag bit; and
determining at least one of size information and position information of the SBT mode corresponding to the current block based on the target flag bit corresponding to the SBT mode.

In other words, in this embodiment of this disclosure, some or all flag bits corresponding to the SBT mode may be determined based on the target quantization coefficient.

In some embodiments, when the target flag bit includes some flag bits corresponding to the SBT mode, other flag bits may be obtained through entropy decoding. For example, the other flag bits may be determined through a particular flag bit in a decoded bit stream. In other words, the coder side may code only the other flag bits, and implicitly indicate the target flag bit through the quantization coefficient. Alternatively, in some other implementations, the other flag bits may be preset, or values of the other flag bits are a default value, for example, 0 or 1.

In some embodiments, the target flag bit includes a position flag bit (for example, includes a horizontal position flag bit and a vertical position flag bit). In this case, the size flag bit corresponding to the SBT mode may be obtained through entropy decoding.

In some embodiments, the target flag bit includes the horizontal position flag bit. In this case, a value of the vertical position flag bit may be obtained through entropy decoding. For example, the value may be determined through a particular flag bit in the decoded bit stream. In some embodiments, the size flag bit corresponding to the SBT mode may also be obtained through entropy decoding.

In some embodiments, the target flag bit includes the vertical position flag bit. In this case, a value of the horizontal position flag bit may be obtained through entropy decoding. For example, the value may be determined through a particular flag bit in the decoded bit stream. In some embodiments, the size flag bit corresponding to the SBT mode may also be obtained through entropy decoding. For example, the size flag bit may be determined through a particular flag bit in the decoded bit stream.

In some embodiments, the target flag bit includes a size flag bit configured for identifying a horizontal size and a vertical size of the SBT. In this case, the position flag bit corresponding to the SBT mode may be obtained through entropy decoding. For example, the position flag bits may be determined through a particular flag bit in the decoded bit stream.

In some embodiments of this disclosure, the target region is a region in which the current block is located. In other words, the target region includes an entire region in which the current block is located. In this case, a candidate quantization coefficient includes an entire quantization coefficient matrix corresponding to the current block.

In some other embodiments of this disclosure, the target region is a region in which a non-zero coefficient in the current block is located. In this case, the candidate quantization coefficient includes only a quantization coefficient matrix in the region in which the non-zero coefficient is located. For example, the target region may be a scan region-based coefficient coding (SRCC) region in the current block. This manner helps reduce calculation complexity on the decoder side and improve a processing speed, and facilitates hardware implementation.

In some embodiments, the target region may be preset. In other words, the decoder side and the coder side have a consistent understanding of the target region. For example, the coder side sets the target quantization coefficient in the target region based on the flag bit of the SBT mode, and the decoder sider determines the SBT mode based on the target quantization coefficient in the target region, so that the coder side and the decoder side have a consistent understanding of the SBT mode used for the current block.

In this embodiment of this disclosure, the target quantization coefficient may include some or all quantization coefficients in the target region. In other words, the decoder side may determine the SBT mode based on some or all of the quantization coefficients in the target region. An implementation of the target quantization coefficient in the target region is described below in combination with an embodiment.

Manner 1: The target quantization coefficient may include all quantization coefficients in the target region.

Manner 2: The target quantization coefficient includes quantization coefficients at X preset positions in the target region, X being a positive integer.

In some embodiments, positions of the X preset positions in the target region may be preset.

In some embodiments, a value of X is preset. For example, X=1. Alternatively, X is greater than 1, for example, X=2. For example, X=1. The preset position may be a position in the first row and the first column, or may be a position in the last row and the last column in the target region.

Manner 3: The target quantization coefficient includes M rows of quantization coefficients in the target region, M being a positive integer.

In some embodiments, positions of the M rows of quantization coefficients in the target region may be preset.

In some embodiments, a value of M is preset. For example, M=1. Alternatively, M is greater than 1, for example, M=2.

For example, M=1 and the target region is a 4*4 quantization coefficient block. As shown in FIG. 8 (a), the M rows of quantization coefficients may be the first row of quantization coefficients in the target region, or may be the last row of quantization coefficients.

For example, M=2 and the target region is a 4*4 quantization coefficient block. As shown in FIG. 8 (b), the M rows of quantization coefficients may be the last two rows of quantization coefficients in the target region, or may be the first two rows of quantization coefficients, or may be the middle two rows of quantization coefficients, or may be odd-numbered rows of quantization coefficients, or may be even-numbered rows of quantization coefficients.

Manner 4: The target quantization coefficient includes N columns of quantization coefficients in the target region, N being a positive integer.

In some embodiments, positions of the N columns of quantization coefficients in the target region may be preset.

In some embodiments, a value of N is preset. For example, N=1. Alternatively, N is greater than 1, for example, N=2.

For example, N=1 and the target region is a 4*4 quantization coefficient block. As shown in FIG. 8 (c), the N columns of quantization coefficients may be the first column of quantization coefficients in the target region, or may be the last column of quantization coefficients.

For example, N=2 and the target region is a 4*4 quantization coefficient block. As shown in FIG. 8 (d), the N columns of quantization coefficients may be the last two columns of quantization coefficients in the target region, or may be the first two columns of quantization coefficients, or may be the middle two columns of quantization coefficients, or may be odd-numbered columns of quantization coefficients, or may be even-numbered columns of quantization coefficients.

Manner 5: The target quantization coefficient includes P rows of quantization coefficients and Q columns of quantization coefficients in the target region, P and Q being positive integers.

In some embodiments, positions of the P rows and Q columns of quantization coefficients in the target region may be preset.

In some embodiments, a value of P is preset. For example, P=1. Alternatively, P is greater than 1, for example, P=2.

In some embodiments, a value of Q is preset. For example, Q=1. Alternatively, Q is greater than 1, for example, Q=2.

For example, P=Q=1 and the target region is a 4*4 quantization coefficient block. As shown in FIG. 8 (e), the P rows and Q columns of quantization coefficients may include the last row of quantization coefficients and the last column of quantization coefficients in the target region, or as shown in FIG. 8 (g), may include the first row of quantization coefficients and the first column of quantization coefficients in the target region, or the like.

For example, P=Q=2 and the target region is a 4*4 quantization coefficient block. As shown in FIG. 8 (f), the P rows and Q columns of quantization coefficients may include the last two rows of quantization coefficients and the last two columns of quantization coefficients in the target region, or as shown in FIG. 8 (h), may include the first two rows of quantization coefficients and the first two columns of quantization coefficients in the target region, or may include odd-numbered rows of quantization coefficients and odd-numbered columns of quantization coefficients, or may include even-numbered rows of quantization coefficients and even-numbered columns of quantization coefficients.

Manner 6: The target quantization coefficient includes quantization coefficients at positions on K oblique lines in the target region, K being a positive integer.

In some embodiments, positions of the positions on the K oblique lines in the target region may be preset.

In some embodiments, a value of K is preset. For example, K=1. Alternatively, K is greater than 1, for example, K=2.

For example, K=1 and the target region is a 4*4 quantization coefficient block. As shown in FIG. 8 (i), the quantization coefficients at the positions on the K oblique lines may be quantization coefficients at positions on the second-to-last oblique line in the target region, or as shown in FIG. 8 (j), may be quantization coefficients at positions on the third-to-last oblique line, or may be quantization coefficients on a diagonal.

For example, K=2 and the target region is a 4*4 quantization coefficient block. As shown in FIG. 8 (k), the quantization coefficients at the positions on the K oblique lines may include quantization coefficients on positions of the last and the second-to-last oblique lines in the target region, or as shown in (1) in FIG. 8, may include quantization coefficients at positions on the second-to-last and third-to-last oblique lines, or may include quantization coefficients on a diagonal and an adjacent oblique line.

In FIG. 8, the target region is exemplified as a 4*4 quantization coefficient block, but this disclosure is not limited thereto. For example, the target region may alternatively be an 8*8 quantization coefficient block, a 16*16 quantization coefficient block, or the like. In addition, each block in FIG. 8 represents a quantization coefficient, and a region in which a gray block is located may be considered as a statistical region configured for determining the SBT mode corresponding to the current block.

Manner 7: The target quantization coefficient includes quantization coefficients at Y preset positions in a scan order of the current block, Y being a positive integer.

In some embodiments, positions of the Y preset positions in the target region may be preset.

In some embodiments, a value of Y is preset. For example, Y=1. Alternatively, Y is greater than 1, for example, Y=2.

For example, the target quantization coefficient may include first Y quantization coefficients, or middle N quantization coefficients, or last Y quantization coefficients in the scan order.

In some embodiments of this disclosure, the decoder side may further determine whether to implicitly derive the SBT mode through the quantization coefficient. For example, when determining to implicitly derive the SBT mode through the quantization coefficient, the decoder side performs operations in S610 to S630.

In some embodiments of this disclosure, the method 600 further includes:
obtaining at least one of a first index and a size of the current block, the first index being configured for indicating whether to determine the SBT mode corresponding to the current block based on the target quantization coefficient; and
determining, based on at least one of the first index and the size of the current block, whether to determine the SBT mode corresponding to the current block based on the target quantization coefficient in the target region in the current block.

In some embodiments, the obtaining a first index includes:
obtaining the first index from at least one of a sequence header corresponding to the current block, an image header corresponding to the current block, a slice header corresponding to the current block, and an LCU corresponding to the current block.

In some embodiments, the decoder side may obtain the first index from the sequence header corresponding to the current block. For example, the sequence header is decoded to obtain the first index. In this case, the first index indicates that an SBT mode needs to be determined for all CUs in a video image frame sequence corresponding to the sequence header based on the quantization coefficient. For example, one or more flag bits corresponding to the SBT mode are determined based on the quantization coefficient.

In some embodiments, the decoder side may obtain the first index from the image header corresponding to the current block. For example, the image header is decoded to obtain the first index. In this case, the first index indicates that an SBT mode needs to be determined for all CUs in a video image frame corresponding to the image header based on the quantization coefficient. For example, one or more flag bits corresponding to the SBT mode are determined based on the quantization coefficient.

In some embodiments, the decoder side may obtain the first index from the slice header corresponding to the current block. For example, the slice header is decoded to obtain the first index. In this case, the first index indicates that an SBT mode needs to be determined for all CUs in a slice based on the quantization coefficient. For example, one or more flag bits corresponding to the SBT mode are determined based on the quantization coefficient.

In some embodiments, the decoder side may obtain the first index from the LCU corresponding to the current block. For example, the LCU is decoded to obtain the first index. In this case, the first index indicates that an SBT mode needs to be determined for all CUs in an LCU based on the quantization coefficient. For example, one or more flag bits corresponding to the SBT mode are determined based on the quantization coefficient.

In some embodiments, the decoder side may further obtain the size of the current block, and determine whether to determine the SBT mode based on the quantization coefficient depending on whether the size of the current block is within a preset range. In other words, the coder side may indicate, through the size of the current block, whether the SBT mode used for the current block needs to be determined based on the quantization coefficient for the current block. For example, when the size of the current block is within the preset range, the SBT mode corresponding to the current block is determined based on the target quantization coefficient in the target region in the current block.

In some embodiments of this disclosure, S620 includes:
determining a statistical value of the target quantization coefficient in the target region, or performing statistical processing on the target quantization coefficient; and
determining the SBT mode corresponding to the current block based on the statistical value of the target quantization coefficient.

For example, a value of a target flag bit of the SBT mode corresponding to the current block is determined based on the statistical value of the target quantization coefficient.

In some embodiments, the determining a statistical value of the target quantization coefficient in the target region includes:
summing all of the quantization coefficients included in the target quantization coefficient to obtain the statistical value of the target quantization coefficient; or
summing absolute values of all of the quantization coefficients included in the target quantization coefficient to obtain the statistical value of the target quantization coefficient; or
mapping all of the quantization coefficients included in the target quantization coefficient, and determining the statistical value of the target quantization coefficient based on a mapping value of each quantization coefficient.

Mapping the quantization coefficient may be mapping original values of the quantization coefficients, or may be mapping absolute values of the quantization coefficients.

In some implementations, the mapping all of the quantization coefficients included in the target quantization coefficient may, for example, include: mapping the quantization coefficients based on parity. For example, an even coefficient and an odd coefficient in the target quantization coefficient are respectively mapped to a first value and a second value, the first value and the second value being different.

As an example, the first value is 1, and the second value is 0.

As another example, the first value is 0, and the second value is 1.

As yet another example, the first value is 2, and the second value is 3.

As still yet another example, the first value is 3, and the second value is 2.

In some other implementations, the mapping all of the quantization coefficients included in the target quantization coefficient may, for example, include: respectively mapping a zero coefficient and a non-zero coefficient in the target quantization coefficient to a third value and a fourth value, the third value and the fourth value being different.

As an example, the third value is 1, and the fourth value is 0.

As another example, the third value is 0, and the fourth value is 1.

As yet another example, the third value is 3, and the fourth value is 2.

As still yet another example, the third value is 2, and the fourth value is 3.

The foregoing mapping manner is merely an example. The embodiments of this disclosure may further adopt another mapping manner such as inverse mapping, mapping minus one, or mapping plus one, and this disclosure is not limited thereto.

In some embodiments, the determining the statistical value of the target quantization coefficient based on a mapping value of each quantization coefficient may, for example, include:
summing the mapping values of all of the quantization coefficients to obtain the statistical value of the target quantization coefficient; or summing the absolute values of the mapping values of all of the quantization coefficients to obtain the statistical value of the target quantization coefficient.

In some embodiments, the performing statistical processing on the target quantization coefficient may include:
performing statistics collection about parity of a quantity of even coefficients in the target quantization coefficient, or performing statistics collection about parity of a quantity of odd coefficients in the target quantization coefficient.

For example, if the quantity of even coefficients in the target quantization coefficient is an odd number, the statistical value of the target quantization coefficient may be a fifth value; and if the quantity of even coefficients in the target quantization coefficient is an even number, the statistical value of the target quantization coefficient may be a sixth value, the fifth value and the sixth value being different. For example, the fifth value is 0, and the sixth value is 1, or vice versa.

For another example, if the quantity of odd coefficients in the target quantization coefficient is an odd number, the statistical value of the target quantization coefficient may be a seventh value; and if the quantity of odd coefficients in the target quantization coefficient is an even number, the statistical value of the target quantization coefficient may be an eighth value, the seventh value and the eighth value being different. For example, the seventh value is 0, and the eighth value is 1, or vice versa.

In some embodiments, the determining the SBT mode corresponding to the current block based on the statistical value of the target quantization coefficient includes:
performing a remainder operation on the statistical value of the target quantization coefficient with respect to L, L being a positive integer greater than 1; and
determining the SBT mode corresponding to the current block based on a result of the remainder operation on the statistical value of the target quantization coefficient. For example, the value of the target flag bit of the SBT mode corresponding to the current block is determined based on the result of the remainder operation on the statistical value of the target quantization coefficient.

In some embodiments, the determining the SBT mode corresponding to the current block based on a result of the remainder operation on the statistical value of the target quantization coefficient may include:
determining the value of the target flag bit of the SBT mode corresponding to the current block based on the result of the remainder operation on the statistical value of the target quantization coefficient and a first mapping relationship, the first mapping relationship being a mapping relationship between a different states value of the result of the remainder operation and the value of the target flag bit.

In some embodiments, L results of the remainder operation (0 to L−1) on the statistical value of the target quantization coefficient may correspond to L states. The L states may implicitly indicate L values of the target flag bit.

For example, L=4. In this case, the result of the remainder operation may range from 0 to 3, which correspond to four state values. The four state values may be configured for indicating different values of the target flag bit. For example, the target flag bit includes a position flag bit (for example, hor_idx, ver_idx). In this case, the four state values of the result of the remainder operation may correspond to different values of the position flag bit, for example, four values, i.e., 00, 01, 10, and 11, of (hor_idx, ver_idx) in Table 1.

As an example, a state value of 00 of the result of the remainder operation corresponds to the value of 00 of (hor_idx, ver_idx), a state value of 01 of the result of the remainder operation corresponds to the value 01 of (hor_idx, ver_idx), a state value of 10 of the result of the remainder operation corresponds to the value 10 of (hor_idx, ver_idx), and a state value of 11 of the result of the remainder operation corresponds to the value 11 of (hor_idx, ver_idx).

For example, L=2. In this case, the result of the remainder operation may range from 0 to 1, and corresponds to two state values. The two state values may be configured for indicating different values of the target flag bit.

For example, the target flag bit includes a horizontal position flag bit (for example, hor_idx). In this case, the two state values of the result of the remainder operation may correspond to two values, i.e., 0 and 1, of the horizontal position flag bit (for example, hor_idx). For example, a state value of 0 of the result of the remainder operation corresponds to the value of 0 of the horizontal position flag bit, and a value of 1 of the result of the remainder operation corresponds to the value of 1 of the horizontal position flag bit. In an implementation example, statistics collection about parity of a quantity of even coefficients in all of the quantization coefficients in the target quantization coefficient may be performed. If the quantity is an odd number, the value of the horizontal position flag bit is determined as 0, and if the quantity is an even number, the value of the horizontal position flag bit is determined as 1, or vice versa.

For another example, the target flag bit includes a vertical position flag bit. In this case, the two state values of the result of the remainder operation may correspond to two values, i.e., 0 and 1, of the vertical position flag bit (for example, ver_idx). For example, a state value of 0 of the result of the remainder operation corresponds to the value of 0 of the vertical position flag bit, and a state value of 1 of the result of the remainder operation corresponds to the value of 1 of the vertical position flag bit. In an implementation example, statistics collection about parity of a quantity of even coefficients in all of the quantization coefficients in the target quantization coefficient may be performed. If the quantity is an odd number, the value of the vertical position flag bit is determined as 0, and if the quantity is an even number, the value of the vertical position flag bit is determined as 1, or vice versa.

In some embodiments, when L=2, information of one flag bit of the SBT mode may be derived. Values of other flag bits of the SBT mode may be obtained through entropy decoding. For example, a value is obtained through decoding of a particular flag bit in a bit stream. Alternatively, the values of the other flag bits are a default value. For example, the values are 1 or 0 by default.

In some embodiments, in a case that the target flag bit includes a plurality of flag bits, the plurality of flag bits are determined based on a target quantization coefficient in one target region, or the plurality of flag bits are determined based on target quantization coefficients in a plurality of target regions. In other words, the target quantization coefficient in one target region may be configured for determining values of a plurality of flag bits, or the target quantization coefficient in one target region may be configured for determining a value of one flag bit.

When a plurality of flag bits are determined based on a plurality of target regions, the plurality of target regions may not overlap each other, or may partially overlap, which is not limited in this disclosure. The target quantization coefficients in the plurality of target regions may be determined in the same manner, or may be determined in different manners. For example, the target quantization coefficients may be determined in different manners of the foregoing Manner 1 to Manner 7.

For example, when the target flag bit includes a horizontal position flag bit and a vertical position flag bit (for example, hor_idx, ver_idx), the decoder side may determine two target regions (denoted as a first target region and a second target region). A target quantization coefficient in the first target region is configured for determining a value of the horizontal position flag bit, and a target quantization coefficient in the second target region is configured for determining a value of the vertical position flag bit. For example, the decoder side may perform statistics collection on the target quantization coefficient in the first target region, and determine the value of the horizontal position flag bit based on a statistical value of the target quantization coefficient in the first target region. For example, a remainder operation is performed on the statistical value with respect to 2, and the value of the horizontal position flag bit is determined based on a result of the remainder operation. The decoder side may perform statistics collection on the target quantization coefficient in the second target region, and determine the value of the vertical position flag bit based on a statistical value of the target quantization coefficient in the second target region. For example, a remainder operation is performed on the statistical value with respect to 2, and the value of the vertical position flag bit is determined based on a result of the remainder operation. For a specific determining manner, reference is made to the description of the foregoing embodiments. For brevity, details are not described herein.

For another example, when the target flag bit includes a horizontal position flag bit and a vertical position flag bit (for example, hor_idx, ver_idx), the decoder side may determine a target region, and determine the horizontal position flag bit and the vertical position flag bit based on a target quantization coefficient in the target region. For example, the decoder side performs statistics collection on the target quantization coefficient in the target region, and determines the values of the horizontal position flag bit and the vertical position flag bit based on a statistical value of the target quantization coefficient in the target region. For example, a remainder operation is performed on the statistical value with respect to 4, and the values of the horizontal position flag bit and the vertical position flag bit are determined based on a result of the remainder operation. For a specific determining manner, reference is made to the description of the foregoing embodiments. For brevity, details are not described herein.

Based on the above, in the embodiments of this disclosure, the decoder side may implicitly derive some or all of flag bits of the SBT mode based on the statistical value of the quantization coefficient, which can reduce a price of coding the flag bits of the SBT mode by the coder side, save a bit rate, and improve the coding and decoding efficiency.

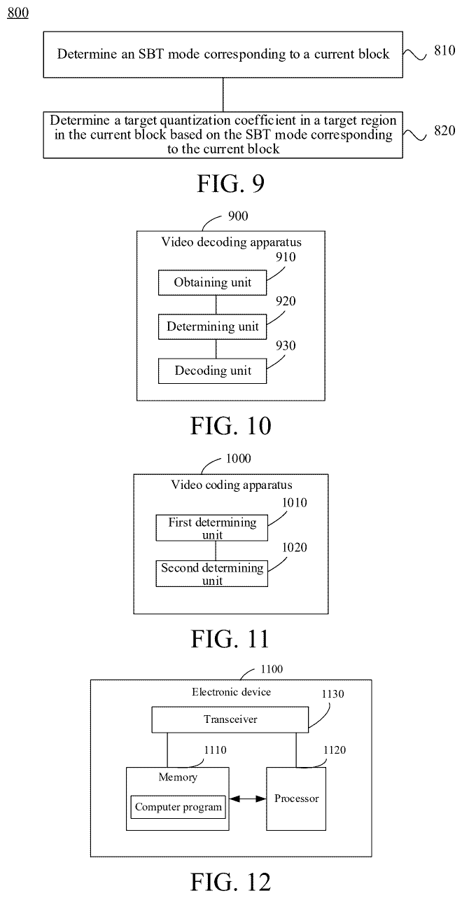

FIG. 9 is a flowchart of a video coding method according to an embodiment of this disclosure. The video coding method may be performed by a coder side. The coder side may be a device with a computing processing function, or may be arranged in a device with a computing processing function. The device with a computing processing function may be, for example, a terminal device or a server. As shown in FIG. 9, a video coding method 800 may include at least some of the following contents:

S810: Determine an SBT mode corresponding to a current block.

S820: Determine a target quantization coefficient in a target region in the current block based on the SBT mode corresponding to the current block.

Therefore, in this embodiment of this disclosure, the coder side determines the target quantization coefficient in the target region in the current block based on the SBT mode corresponding to the current block, to implicitly indicate the SBT mode corresponding to the current block to a decoder side through the target quantization coefficient in the target region in the current block, so that the coder side may not explicitly code a flag bit of the SBT mode used for the current block, thereby saving a bit rate and improving coding and decoding efficiency.

The behavior of implicitly indicating the SBT mode through the quantization coefficient by the coder side corresponds to a behavior of obtaining the SBT mode through the quantization coefficient by the decoder side. For similar description, reference is made to the detailed description of the decoder side. For brevity, details are not described herein.

In some embodiments, the coder side may determine the SBT mode corresponding to the current block through RDO.

In some embodiments of this disclosure, the target region is a region which the current block is located in; or
the target region is a region in which a non-zero coefficient in the current block is located.

In some embodiments of this disclosure, the target quantization coefficient includes all quantization coefficients in the target region; or
the target quantization coefficient includes quantization coefficients at X preset positions in the target region, X being a positive integer; or
the target quantization coefficient includes M rows of quantization coefficients in the target region, M being a positive integer; or
the target quantization coefficient includes N columns of quantization coefficients in the target region, N being a positive integer; or
the target quantization coefficient includes P rows of quantization coefficients and Q columns of quantization coefficients in the target region, P and Q being positive integers; or
the target quantization coefficient includes quantization coefficients at positions on K oblique lines in the target region, K being a positive integer; or
the target quantization coefficient includes quantization coefficients at Y preset positions in a scan order of the current block, Y being a positive integer.

In some embodiments of this disclosure, the method 800 further includes:
determining a size of the current block, the size of the current block being configured for determining whether to determine the SBT mode corresponding to the current block based on the target quantization coefficient.

In some embodiments of this disclosure, the method 800 further includes:
coding a first index into at least one of a sequence header corresponding to the current block, an image header corresponding to the current block, a slice header corresponding to the current block, and an LCU corresponding to the current block, the first index being configured for indicating whether to determine the SBT mode corresponding to the current block based on the target quantization coefficient.

In some embodiments, the SBT mode is represented by a size flag bit and a position flag bit, the size flag bit being configured for identifying at least one of a horizontal size and a vertical size of the SBT, and the position flag bit being configured for identifying at least one of a horizontal position and a vertical position of the SBT.

In some embodiments, the position flag bit includes at least one of the following flag bits:
a horizontal position flag bit, configured for identifying a horizontal position of the SBT; and
a vertical position flag bit, configured for identifying a vertical position of the SBT.

In some embodiments, the determining a target quantization coefficient in a target region in the current block based on the SBT mode corresponding to the current block includes:
determining a target statistical value based on a target flag bit of the SBT mode corresponding to the current block, the target flag bit including at least one of a size flag bit and a position flag bit; and
adjusting the target quantization coefficient in the target region in the current block based on a statistics collection rule of the target quantization coefficient, so that the statistical value of the target quantization coefficient is consistent with the target statistical value.

In some implementations, the statistical value of the target quantization coefficient in the target region and a value of the target flag bit corresponding to the SBT mode satisfy a specific mapping relationship. Therefore, the coder side may determine the value of the target flag bit based on the selected SBT mode, and determine, in combination with the mapping relationship, the target statistical value the target quantization coefficient needs to satisfy, and then adjust the target quantization coefficient so that the target quantization coefficient satisfies the target statistical value, thereby indicating the target flag bit of the SBT mode to the decoder side.

In some implementation examples, the statistical value of the target quantization coefficient is parity of a quantity of even coefficients in all quantization coefficients included in the target quantization coefficient. For example, a value of 0 of the horizontal position flag bit corresponds to an odd quantity of the even coefficients, and a value of 1 of the horizontal position flag bit corresponds to an even quantity of the even coefficients. If the horizontal position flag bit corresponding to the SBT mode selected by the coder side is 0, the coder side needs to adjust the value of the target quantization coefficient so that the quantity of the even coefficients in all of the quantization coefficients is an odd number; or if the horizontal position flag bit corresponding to the SBT mode selected by the coder side is 1, the coder side needs to adjust the value of the target quantization coefficient so that the quantity of the even coefficients in all of the quantization coefficients is an even number.

The foregoing statistics collection manner of the target quantization coefficient is merely an example, and this disclosure is not limited thereto. For example, the statistical value of the target quantization coefficient may alternatively be a sum of all quantization coefficients included in the target quantization coefficient; or the statistical value of the target quantization coefficient may be a sum of absolute values of all of the quantization coefficients included in the target quantization coefficient; or the statistical value of the target quantization coefficient may be a statistical value of mapping values of all of the quantization coefficients included in the target quantization coefficient. For example, the statistical value of the target quantization coefficient may be the sum of the mapping values of all of the quantization coefficients, or may be the sum of the absolute values of all of the quantization coefficients.

In some embodiments, the mapping values of an even coefficient and an odd coefficient in the target quantization coefficient are respectively a first value and a second value, the first value and the second value being different.

In some embodiments, the first value is 1, and the second value is 0.

In some embodiments, the first value is 0, and the second value is 1.

In some embodiments, the first value is 2, and the second value is 3.

In some embodiments, the mapping values of a zero coefficient and a non-zero coefficient in the target quantization coefficient are respectively a third value and a fourth value, the third value and the fourth value being different.

In some embodiments, the third value is 1, and the fourth value is 0.

In some embodiments, the third value is 0, and the fourth value is 1.

In some embodiments, the third value is 3, and the fourth value is 2.

In some embodiments, in a case that the target flag bit includes a plurality of flag bits, the plurality of flag bits are configured for determining a value of a target quantization coefficient in one target region, or the plurality of flag bits are configured for determining values of target quantization coefficients in a plurality of target regions.

The video coding and decoding method in the embodiments of this disclosure is applicable to a video codec or a video compression product using an SBT technology.

An apparatus embodiment of this disclosure is described below, which may be configured for performing the method in the foregoing embodiment of this disclosure. For details not disclosed in the apparatus embodiment of this disclosure, reference may be made to the foregoing method embodiment of this disclosure.

FIG. 10 is a block diagram of a video decoding apparatus according to an embodiment of this disclosure. The video decoding apparatus may be arranged in a device with a computing processing function, such as a terminal device or a server.

As shown in FIG. 10, a video decoding apparatus 900 according to an embodiment of this disclosure includes an obtaining unit 910, a determining unit 920, and a decoding unit 930.

In some embodiments, the obtaining unit 910 is configured to obtain a target quantization coefficient in a target region in a current block.

The determining unit 920 is configured to determine an SBT mode corresponding to the current block based on the target quantization coefficient in the target region.

The decoding unit 930 is configured to decode the current block based on the SBT mode corresponding to the current block.

In some embodiments, the SBT mode is represented by a size flag bit and a position flag bit, the size flag bit being configured for identifying at least one of a horizontal size and a vertical size of the SBT, and the position flag bit being configured for identifying at least one of a horizontal position and a vertical position of the SBT.

In some embodiments, the determining unit 920 is further configured to:
determine a target flag bit corresponding to the SBT mode based on the target quantization coefficient in the target region, the target flag bit including at least one of a size flag bit and a position flag bit; and
determine at least one of size information and position information of the SBT mode corresponding to the current block based on the target flag bit corresponding to the SBT mode.

In some embodiments, the target region is a region in which the current block is located; or
the target region is a region in which a non-zero coefficient in the current block is located.

In some embodiments, the target quantization coefficient includes all quantization coefficients in the target region; or
the target quantization coefficient includes quantization coefficients at X preset positions in the target region, X being a positive integer; or
the target quantization coefficient includes M rows of quantization coefficients in the target region, M being a positive integer; or
the target quantization coefficient includes N columns of quantization coefficients in the target region, N being a positive integer; or
the target quantization coefficient includes P rows of quantization coefficients and Q columns of quantization coefficients in the target region, P and Q being positive integers; or
the target quantization coefficient includes quantization coefficients at positions on K oblique lines in the target region, K being a positive integer, or
the target quantization coefficient includes quantization coefficients at Y preset positions in a scan order of the current block, Y being a positive integer.

In some embodiments, the obtaining unit 910 is further configured to obtaining at least one of a first index and a size of the current block, the first index being configured for indicating whether to determine the SBT mode corresponding to the current block based on the target quantization coefficient.

In some embodiments, the determining unit 920 is further configured to determine, based on at least one of the first index and the size of the current block, whether to determine the SBT mode corresponding to the current block based on the target quantization coefficient in the target region in the current block.

In some embodiments, the obtaining unit 910 is further configured to:
obtain the first index from at least one of a sequence header corresponding to the current block, an image header corresponding to the current block, a slice header corresponding to the current block, and an LCU corresponding to the current block.

In some embodiments, the determining unit 920 is further configured to:
determine the SBT mode corresponding to the current block based on the target quantization coefficient in the target region in the current block in a case that the size of the current block is within a preset range.

In some embodiments, the determining unit 920 is further configured to:
determine a statistical value of the target quantization coefficient in the target region; and
determine the SBT mode corresponding to the current block based on the statistical value of the target quantization coefficient.

In some embodiments, the determining unit 920 is further configured to:
sum all of the quantization coefficients included in the target quantization coefficient to obtain the statistical value of the target quantization coefficient; or
sum absolute values of all of the quantization coefficients included in the target quantization coefficient to obtain the statistical value of the target quantization coefficient; or
map all of the quantization coefficients included in the target quantization coefficient, and determine the statistical value of the target quantization coefficient based on a mapping value of each quantization coefficient.

In some embodiments, the determining unit 920 is further configured to:
respectively map an even coefficient and an odd coefficient in the target quantization coefficient to a first value and a second value, the first value and the second value being different; or
respectively map a zero coefficient and a non-zero coefficient in the target quantization coefficient to a third value and a fourth value, the third value and the fourth value being different.

In some embodiments, the first value is 1, and the second value is 0; or
the first value is 0, and the second value is 1; or
the first value is 2, and the second value is 3; or
the third value is 1, and the fourth value is 0; or
the third value is 0, and the fourth value is 1; or
the third value is 3, and the fourth value is 2.

In some embodiments, the determining unit 920 is further configured to:
sum the mapping values of all of the quantization coefficients, to obtain the statistical value of the target quantization coefficient; or
sum the absolute values of the mapping values of all of the quantization coefficients to obtain the statistical value of the target quantization coefficient.

In some embodiments, the determining unit 920 is further configured to:
perform a remainder operation on the statistical value of the target quantization coefficient with respect to L, L being a positive integer greater than 1; and
determine the SBT mode corresponding to the current block based on a result of the remainder operation on the statistical value of the target quantization coefficient.

In some embodiments, the determining unit 920 is further configured to:
determine a value of a target flag bit corresponding to the SBT mode based on the result of the remainder operation on the statistical value of the target quantization coefficient and a first mapping relationship, the target flag bit including at least one of the size flag bit and the position flag bit, and the first mapping relationship being a mapping relationship between a different state value of the result of the remainder operation and the value of the target flag bit; and
determine at least one of size information and position information of the SBT mode corresponding to the current block based on the target flag bit corresponding to the SBT mode.

In some embodiments, the position flag bit includes at least one of the following flag bits:
a horizontal position flag bit, configured for identifying a horizontal position of the SBT; and
a vertical position flag bit, configured for identifying a vertical position of the SBT.

In some embodiments, in a case that the target flag bit includes a plurality of flag bits, the plurality of flag bits are determined based on target quantization coefficients in the same target region, or the plurality of flag bits are determined based on target quantization coefficients in a plurality of target regions.

FIG. 11 is a block diagram of a video coding apparatus according to an embodiment of this disclosure. The video coding apparatus may be arranged in a device with a computing processing function, such as a terminal device or a server.

As shown in FIG. 11, a video coding apparatus 1000 according to an embodiment of this disclosure includes a first determining unit 1010 and a second determining unit 1020. The first determining unit 1010 is configured to determine an SBT mode corresponding to a current block, and the second determining unit 1020 is configured to determine a target quantization coefficient in a target region in a current block based on the SBT mode corresponding to the current block.

In some embodiments of this disclosure, the target region is a region which the current block is located in; or the target region is a region in which a non-zero coefficient in the current block is located.

In some embodiments of this disclosure, the target quantization coefficient includes all quantization coefficients in the target region; or
the target quantization coefficient includes quantization coefficients at X preset positions in the target region, X being a positive integer; or
the target quantization coefficient includes M rows of quantization coefficients in the target region, M being a positive integer; or
the target quantization coefficient includes N columns of quantization coefficients in the target region, N being a positive integer; or
the target quantization coefficient includes P rows of quantization coefficients and Q columns of quantization coefficients in the target region, P and Q being positive integers; or
the target quantization coefficient includes quantization coefficients at positions on K oblique lines in the target region, K being a positive integer, or
the target quantization coefficient includes quantization coefficients at Y preset positions in a scan order of the current block, Y being a positive integer.

In some embodiments of this disclosure, the second determining unit 1020 is further configured to:
determine a size of the current block, the size of the current block being configured for determining whether to determine the SBT mode corresponding to the current block based on the target quantization coefficient.

In some embodiments of this disclosure, the video coding apparatus 1000 further includes:
a coding unit, configured to code a first index into at least one of a sequence header corresponding to the current block, an image header corresponding to the current block, a slice header corresponding to the current block, and an LCU corresponding to the current block, the first index being configured for indicating whether to determine the SBT mode corresponding to the current block based on the target quantization coefficient.

In some embodiments of this disclosure, the second determining unit 1020 is further configured to:
determine a target statistical value based on a target flag bit of the SBT mode corresponding to the current block; and
adjust the value of the target quantization coefficient in the target region in the current block based on a statistics collection rule of the target quantization coefficient, so that the statistical value of the target quantization coefficient is consistent with the target statistical value.

In some embodiments, the statistical value of the target quantization coefficient is a sum of all of the quantization coefficients included in the target quantization coefficient; or
the statistical value of the target quantization coefficient is a sum of absolute values of all of the quantization coefficients included in the target quantization coefficient; or
the statistical value of the target quantization coefficient is a statistical value of mapping values of all of the quantization coefficients included in the target quantization coefficient.

In some embodiments, the mapping values of an even coefficient and an odd coefficient in the target quantization coefficient are respectively a first value and a second value, the first value and the second value being different; or
the mapping values of a zero coefficient and a non-zero coefficient in the target quantization coefficient are respectively a third value and a fourth value, the third value and the fourth value being different.

In some embodiments, the first value is 1, and the second value is 0; or
the first value is 0, and the second value is 1; or
the first value is 2, and the second value is 3; or
the third value is 1, and the fourth value is 0; or
the third value is 0, and the fourth value is 1; or
the third value is 3, and the fourth value is 2.

In some embodiments, the SBT mode is represented by a size flag bit and a position flag bit, the size flag bit being configured for identifying at least one of a horizontal size and a vertical size of the SBT, and the position flag bit being configured for identifying at least one of a horizontal position and a vertical position of the SBT.

In some embodiments of this disclosure, the second determining unit 1020 is further configured to:
determine the target quantization coefficient in the target region in the current block based on the target flag bit corresponding to the SBT mode, the target flag bit including at least one of the size flag bit and the position flag bit.

In some embodiments, the position flag bit includes at least one of the following flag bits:
a horizontal position flag bit, configured for identifying a horizontal position of the SBT; and
a vertical position flag bit, configured for identifying a vertical position of the SBT.

In some embodiments, in a case that the target flag bit includes a plurality of flag bits, the plurality of flag bits are configured for determining a target quantization coefficient in one target region, or the plurality of flag bits are configured for determining target quantization coefficients in a plurality of target regions.

FIG. 12 is a schematic block diagram of an electronic device 1100 according to an embodiment of this disclosure. The electronic device may be the video coding apparatus or the video decoding apparatus above.

As shown in FIG. 12, the electronic device 1100 may include:
a memory 1110 and a processor 1120. The memory 1110 is configured to store a computer program and transmit program code to the processor 1120. In other words, the processor 1120 may invoke the computer program from the memory 1110 and execute the computer program, to implement the method in the embodiments of this disclosure.

In an embodiment of this disclosure, the processor 1120 is configured to:
obtain a target quantization coefficient in a target region in a current block;
determine an SBT mode corresponding to the current block based on the target quantization coefficient in the target region; and
decode the current block based on the SBT mode corresponding to the current block.

In another embodiment of this disclosure, the processor 1120 is configured to:
determine an SBT mode corresponding to a current block; and
determine a target quantization coefficient in a target region in the current block based on the SBT mode corresponding to the current block.

In some embodiments of this disclosure, the processor 1120 may include, but is not limited to:
a general-purpose processor, a digital signal processor (DSP), an application specific integrated circuit (ASIC), a field programmable gate array (FPGA) or another programmable logic device, a discrete gate or a transistor logic device, a discrete hardware component, or the like.

In some embodiments of this disclosure, the memory 1110 includes, but is not limited to:
a volatile memory and/or a nonvolatile memory. The non-volatile memory may be a read-only memory (ROM), a programmable read-only memory (PROM), an erasable programmable read-only memory (EPROM), an electrically erasable programmable read-only memory (EEPROM), or a flash memory. The volatile memory may be a random access memory (RAM) that is used as an external cache. By way of example but not limitation, many forms of RAMs, such as a static random access memory (SRAM), a dynamic random access memory (DRAM), a synchronous dynamic random access memory (SDRAM), a double data rate synchronous dynamic random access memory (DDR SDRAM), an enhanced synchronous dynamic random access memory (ESDRAM), a synch link dynamic random access memory (SLDRAM), and a direct rambus random access memory (DR RAM) may be used.

In some embodiments of this disclosure, the computer program may be divided into one or more modules, and the one or more modules are stored in the memory 1110 and executed by the processor 1120 to complete the method provided in this disclosure. The one or more modules may be a series of computer program instruction segments that can implement specific functions. The instruction segments are configured for describing an execution process of the computer program in the electronic device.

As shown in FIG. 12, the electronic device 1100 may further include:
a transceiver 1130. The transceiver 1130 may be connected to the processor 1120 or the memory 1110.

The processor 1120 may control the transceiver 1130 to communicate with another device. In some examples, the transceiver may transmit information or data to the another device, or may receive information or data transmitted by the another device. The transceiver 1130 may include a transmitter and a receiver. The transceiver 1130 may further include an antenna. One or more antennas may be arranged.

The components of the electronic device are connected through a bus system. In addition to a data bus, the bus system further includes a power bus, a control bus, and a state signal bus.

This disclosure further provides a computer storage medium, having a computer program stored therein, the computer program, when executed by a computer, causing the computer to perform the method in the foregoing method embodiment. Alternatively, an embodiment of this disclosure further provides a computer program product, including instructions, the instructions, when executed by a computer, causing the computer to perform the method in the foregoing method embodiment.

When the embodiments are implemented by using software, all or some of the embodiments may be implemented in a form of a computer program product. The computer program product includes one or more computer instructions. When the computer instruction is loaded and executed on the computer, all or some processes or functions according to the embodiments of this disclosure are generated. The computer may be a general-purpose computer, a dedicated computer, a computer network, or another programmable apparatus. The computer instruction may be stored in the computer-readable storage medium, or may be transmitted from a computer-readable storage medium to another computer-readable storage medium. For example, the computer instruction may be transmitted from a website, a computer, a server, or a data center to another website, computer, server, or data center in a wired manner (for example, through a coaxial cable, an optical fiber, or a digital subscriber line (DSL)) or a wireless manner (for example, in an infrared, radio, or microwave manner). The computer-readable storage medium may be any usable medium that can be accessed by the computer, or may be a data storage device, such as a server or a data center in which one or more usable media are integrated. The usable medium may be a magnetic medium (for example, a floppy disk, a hard disk, or a magnetic tape), an optical medium (for example, a digital video disc (DVD)), a semiconductor medium (for example, a solid state disk (SSD)), or the like.

In the implementation examples of this disclosure, when the foregoing embodiments of this disclosure are applied to a specific product or technology and involve relevant data such as user information, a user permission or consent needs to be obtained, and collection, use, and processing of the relevant data need to comply with relevant laws, regulations, and standards.

It is noted that, modules, algorithms, and operations in the examples described with reference to the embodiments disclosed in this disclosure may be implemented by electronic hardware or a combination of computer software and electronic hardware. Whether the functions are executed by hardware or software depends on specific applications and design constraints of the technical solutions. It is noted that different methods can be used to implement the described functions for each particular application, the different methods shall also fall within the scope of this disclosure.

In the embodiments provided in this disclosure, the disclosed system, apparatus, and method may be implemented in another manner. For example, the apparatus embodiment described above is merely exemplary. For example, division into the modules is merely logical function division, and may be other division during actual implementation. For example, a plurality of modules or components may be combined or integrated into another system, or some features may be ignored or not executed. In addition, the displayed or discussed mutual coupling or direct coupling or communication connection may be implemented through some interfaces. The indirect coupling or communication connection between the apparatuses or modules may be implemented in an electronic, mechanical, or another form.

The modules described as separate components may or may not be physically separated, and the components displayed as modules may or may not be physical modules. They may be located in one place, or may be distributed over a plurality of network units. Some or all of the modules may be selected according to actual needs to implement the objectives of the solutions of the embodiments. For example, the functional modules in the embodiments of this disclosure may be integrated into one processing module, each of the modules may exist alone physically, or two or more modules may be integrated into one module.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

The foregoing descriptions are some implementations of the embodiments of this disclosure, and the protection scope of the embodiments of this disclosure is not limited thereto. Any variation or replacement within the technical scope disclosed in the embodiments of this disclosure shall fall within the protection scope of the embodiments of this disclosure. Therefore, the protection scope of the embodiments of this disclosure shall be subject to the protection scope of the disclosure.

The foregoing descriptions are some implementations of this disclosure, and the protection scope of this disclosure is not limited thereto. Any variation or replacement within the technical scope disclosed in this disclosure shall fall within the protection scope of this disclosure. Therefore, the protection scope of this disclosure shall be subject to the protection scope of the disclosure.

What is claimed is:

1. A method of video decoding, comprising:
obtaining values of one or more target quantization coefficients in a target region of quantization coefficients of a current block;
deriving a sub-block transform (SBT) mode of the current block based on the values of the one or more target quantization coefficients in the target region; and
reconstructing the current block based on the SBT mode of the current block.

2. The method according to claim 1, wherein:
the target region includes all of the quantization coefficients of the current block; or
the target region includes non-zero quantization coefficients in the quantization coefficients of the current block.

3. The method according to claim 1, wherein the one or more target quantization coefficients comprise at least one of:
all of quantization coefficients in the target region;
quantization coefficients at X preset positions in the target region, X being a positive integer;
M rows of quantization coefficients in the target region, M being a positive integer;
N columns of quantization coefficients in the target region, N being a positive integer;
P rows of quantization coefficients and Q columns of quantization coefficients in the target region, P and Q being positive integers;
quantization coefficients at positions on K oblique lines in the target region, K being a positive integer; or
quantization coefficients at Y preset positions in a scan order of the current block, Y being a positive integer.

4. The method according to claim 1, further comprising:
obtaining at least one of a first index and a size of the current block, the first index indicating whether to determine the SBT mode of the current block based on the one or more target quantization coefficients; and
determining, based on at least one of the first index and the size of the current block, whether to determine the SBT mode of the current block based on the one or more target quantization coefficients in the target region in the current block.

5. The method according to claim 4, wherein the obtaining the first index comprises:
obtaining the first index from at least one of a sequence header of a sequence that includes the current block, an image header of a picture that includes the current block, a slice header of a slice that includes the current block, and a largest coding unit (LCU) that includes the current block.

6. The method according to claim 4, wherein the determining comprises:
determining the SBT mode of the current block based on the one or more target quantization coefficients in the target region when the size of the current block is within a preset range.

7. The method according to claim 6, wherein the determining the SBT mode comprises:
determining a statistical value of the one or more target quantization coefficients in the target region; and
determining the SBT mode of the current block based on the statistical value of the one or more target quantization coefficients.

8. The method according to claim 7, wherein the determining the statistical value comprises at least one of:
summing the values of the one or more target quantization coefficients to obtain the statistical value;
summing respective absolute values of the values of the one or more target quantization coefficients to obtain the statistical value; or
determining the statistical value of the one or more target quantization coefficients based on respective mapping values of the one or more target quantization coefficients, the values of the one or more target quantization coefficients being mapped to the respective mapping values.

9. The method according to claim 8, further comprising:
mapping even values in the values of the one or more target quantization coefficients and odd values of the one or more target quantization coefficients respectively to a first value and a second value, the first value being different from the second value; or
mapping zero quantization coefficients and non-zero quantization coefficients in the one or more target quantization coefficients respectively to a third value and a fourth value, the third value being different from the fourth value.

10. The method according to claim 9, wherein the first value and the second value are set by using at least one of:
the first value being 1, and the second value being 0;
the first value being 0, and the second value being 1;
the first value being 2, and the second value being 3;
the third value being 1, and the fourth value being 0;
the third value being 0, and the fourth value being 1; or
the third value being 3, and the fourth value being 2.

11. The method according to claim 8, wherein the determining the statistical value of the one or more target quantization coefficients based on the respective mapping values comprises:
summing the respective mapping values of the one or more target quantization coefficients to obtain the statistical value; or
summing absolute values of the respective mapping values of the one or more target quantization coefficients to obtain the statistical value.

12. The method according to claim 7, wherein the determining the SBT mode of the current block based on the statistical value comprises:
determining a remainder value of the statistical value by a remainder operation with respect to L, L being a positive integer greater than 1; and
determining the SBT mode of the current block based on the remainder value of the statistical value.

13. The method according to claim 12, wherein:
the SBT mode is represented by a size flag bit and a position flag bit, the size flag bit identifying at least one of a horizontal size and a vertical size for the SBT mode, and the position flag bit identifying at least one of a horizontal position and a vertical position for the SBT mode; and
the determining the SBT mode of the current block based on the remainder value comprises:
determining a value of a target flag bit of the SBT mode based on the remainder value and a first mapping relationship, the target flag bit comprising at least one of the size flag bit and the position flag bit, and the first mapping relationship being a mapping relationship between different state values of the remainder value and candidate values of the target flag bit; and
determining at least one of size information and position information for the SBT mode of the current block based on the value of the target flag bit of the SBT mode.

14. The method according to claim 13, wherein the position flag bit comprises at least one of:
a horizontal position flag bit identifying a horizontal position for the SBT mode; and
a vertical position flag bit identifying a vertical position for the SBT mode.

15. The method according to claim 13, wherein when the target flag bit comprises a plurality of flag bits, the plurality of flag bits are determined based on the one or more target quantization coefficients in the target region, or the plurality of flag bits are determined based on target quantization coefficients in a plurality of target regions.

16. A method of video encoding, comprising:
determining a sub-block transform (SBT) mode for a current block;
performing a transform operation on a residual portion of the current block based on the SBT mode to obtain transform coefficients of the current block;
performing a quantization operation on the transform coefficients to obtain quantization coefficients of the current block;
determining at least a value of a target quantization coefficient in a target region of the quantization coefficients of the current block based on the SBT mode of the current block, at least the value of the target quantization coefficient being indicative of the SBT mode; and
encoding a video that includes the current block with at least the value of the target quantization coefficient into coded information in a bitstream.

17. An apparatus for video decoding, comprising processing circuitry configured to:
obtain values of one or more target quantization coefficients in a target region of quantization coefficients of a current block;
derive a sub-block transform (SBT) mode of the current block based on the values of the one or more target quantization coefficients in the target region; and
reconstruct the current block based on the SBT mode of the current block.

18. The apparatus according to claim 17, wherein:
the target region includes all of the quantization coefficients of the current block; or
the target region includes non-zero quantization coefficients in the quantization coefficients of the current block.

19. The apparatus according to claim 17, wherein the one or more target quantization coefficients comprise at least one of:
all of quantization coefficients in the target region;
quantization coefficients at X preset positions in the target region, X being a positive integer;
M rows of quantization coefficients in the target region, M being a positive integer;
N columns of quantization coefficients in the target region, N being a positive integer;
P rows of quantization coefficients and Q columns of quantization coefficients in the target region, P and Q being positive integers;
quantization coefficients at positions on K oblique lines in the target region, K being a positive integer; or
quantization coefficients at Y preset positions in a scan order of the current block, Y being a positive integer.

20. The apparatus according to claim 17, wherein the processing circuitry is configured to:
obtain at least one of a first index and a size of the current block, the first index indicating whether to determine the SBT mode of the current block based on the one or more target quantization coefficients; and
determine, based on at least one of the first index and the size of the current block, whether to determine the SBT mode of the current block based on the one or more target quantization coefficients in the target region in the current block.
